(19) United States
(12) Patent Application Publication
(10) Pub. No.: US 2011/0083188 A1
(43) Pub. Date: Apr. 7, 2011

(54) Virus, trojan, worm and copy protection of audio, video, digital and multimedia, executable files and such installable programs

(76) Inventor: Om Ahuja, Caruthersville, MO (US)

(21) Appl. No.: 12/900,456

(22) Filed: Oct. 7, 2010

Related U.S. Application Data
(60) Provisional application No. 61/249,495, filed on Oct. 7, 2009.

(51) Int. Cl. G06F 21/22

(52) U.S. Cl. 726/24; 726/32

(57) ABSTRACT

A TSR (Terminate and Stay Resident) program based virus, trojan, worm and copy protection of audio, video, digital, multi media, executable files and installable programs. The TSR is co-resident on the chip-set or the CPU of the system; the BIOS and the OS (Operating System), whereby it is an intrinsic part of the system and is uninstallable. The TSR monitors any attempt to copy, play, record, any designated copy protected audio, video, digital, multi media; or any attempt to copy, install or execute any executable files or such installable programs and seeks authorization and or authentication from a clearing house or by using a local authentication key, before playing, recording, storing, executing or installing such digital media. Additionally the TSR generates and inserts a unique digitally encrypted source signature that includes the machine number and the date and time code for pay per use and verification purposes.

### CROSS-REFERENCE TO RELATED APPLICATIONS

This application claims benefit to Provisional Patent Application No. 61/249,495, filed Oct. 7, 2009, the contents of which are incorporated by reference. This application is also related to U.S. application Ser. No. 11/257,353, filed Oct. 24, 2005, which is based on Provisional Patent Application No. 60/620,818 filed Oct. 22, 2004. The contents of both applications are incorporated by reference.

### BACKGROUND OF THE INVENTION

The invention relates to audio, video, and or data Copy-Protected CD/DVD Optical Storage Disks and or Machine Readable Digital Storage Devices. Currently these Machine Readable Digital Storage Medium are very easily copied. Thus due to the piracy of these products, etc., there are measurable and substantial losses of revenues for the artists and producers of these audio, video, and or data CD/DVDs and Machine Readable Digital Media with the easily available Storage Devices such as Memory Sticks, MP3 Players Smart Phones etc.

Up to now there has been no reliable means of copy protection of Machine Readable Digital Media including Software and or a process that would provide Copy-Protection to prevent the illegal or unauthorized copying (piracy) of these Machine Readable Digital Media or for the Copy Protected Designated Data (Multi Media and or EXE Files/Executable Software Application) once it is resident on the hard drive.

As to Virus, Trojan and Worm Protection they can creep in various different ways and lodge them selves in the System (Operating System) and throw it Off-keel often by making the Hard Drive unbootable. The other havoc they may create has to do with destroying Mission Critical Data Stored on the System.

### DESCRIPTION OF THE PRIOR ART

As is well known in the entertainment and the software industry, creative artists and the developers of software products suffer a considerable financial loss due to the illicit copying of the said products (also known as “piracy”). This situation is further aggravated by the easy availability of optical disk recorders and CD/DVD writers that copy such CD and DVD optical media and other Machine Readable Digital Media relatively quickly and inexpensively. Furthermore up to now there has been no adequate means of Copy Protection for Machine Readable Digital Storage Devices such as Memory Sticks, MP3 Players Smart Phones etc.

Such devices can make perfect copies of any given original digital information. Thus despite obvious advantages of any digital media such as the CDs/DVDs, and Machine Readable Digital Storage Devices such as Memory Sticks, MP3 Players Smart Phones etc. there remains this drawbacks that these devices can be easily copied.

Selling any newly developed audio, video and or data (digital property—including but not limited to software packages) caries with it the risk of these being copied directly either on to the Hard Disk drive and or to other machine readable media.

Another Area of Application of this Present Invention in the Present State of the Art: Viruses, Trojans or Worms my be inadvertently clicked “ON” and installed in the background without being detected as Virus, Trojan or Worm. The protection against these is typically designed to protect against them only after these have been discovered to be in the main stream and after the damage has been done on a number of machines.

### OBJECT & THE SUMMARY OF THE INVENTION

The present invention overcomes these above mentioned disadvantages and makes full use of a Terminate and Stay Resident (TSR) Program which remains installed on the computer system (i.e. is Machine Resident) and blocks any attempt to copy any Copy-Protected CDs/DVDs, and Machine Readable Digital Storage Devices such as Memory Sticks, MP3 Players Smart Phones etc.

The TSR keeps track of any Designated Digital Data stored onto the System and or any machine readable media. Any attempt to copy any of the designated data is thwarted by the TSR, (including but not limited to the EXE and such Application Files, Audio and or the Video Data thereon).

The TSR is permanently PRE-INSTALLED into the machine in two or three different ways . . . hence it may not and cannot be uninstalled once it has been installed onto the system.

The TSR additionally Monitors any of the Networking Environment wherein it thwarts any attempt to remotely copy or access any of the Protected Designated copy or access any of the Protected Designated Data. The TSR issues a Copy Right Warning Notice to both the local and the remote system and disconnects the two after warning the user.

Yet another inbuilt feature of the TSR is that it is self replicating . . . any accidental or intentional attempt to locally or remotely delete the TSR in its RUN Mode, can NOT and will not delete it off the system it is installed on. (Neither Statically nor Dynamically e.g. in the Run Mode) Furthermore, it is an object of the present invention to add the TSR (Terminate and Stay Resident) program method of copy protection to any Digital Data Carrier, by reading a key on the original Digital Data Carrier and further by adding the Machine Number on to Destination Digital Copy being made. Thus by keeping track of the from and to (source and destination in each and every copy made and only after it has been authenticated and authorized over the web/internet).

By extracting the key off from the original optical record (Carrier/Digital Media) one distinguishes between an original Digital Media and an attempted copy of an original record and the copied destination. Thus it is an object of the present invention to provide a superior all combined Copy-Protected CDs/DVDs, and Machine Readable Digital Storage Devices such as Memory Sticks, MP3 Players Smart Phones etc. that has a secure multifaceted total Copy Protection.

Thus the Additional Benefit of the Present System is that it keeps Track of all the Copies Made. It becomes very clear as to how many Times a Copy has been made and where is has been made for the Same Source Device. e.g. an mp3 Audio is Copied form one Folder to another Folder on the same System . . . the Tracking of the Source, the Machine Number and Date is Appended to the Copy and thus able to Distinguish and keep Track of the Family Tree with the Parent Child Relationship.

Consequently, the other area of Application of this Present Invention is elimination of the threat of Viruses, Trojans or Worms that may be inadvertently clicked on or creep in and install themselves into the background on to the System without being detected as Virus, Trojan or a Worm.

Traditionally the protection against these is typically designed to protect against them only after these have been discovered in the main stream and after the damage has been done.

According to the Present Invention such incidences would be virtually eliminated as Any and All Executable EXE Files and Applications and or Installations would require an Authentication Process via a Secure Verified Third Party Clearing House and a Secure Verified Manufacturer from a Master List of All Manufacturers of Software Products and Services. Thus any Duplication or Piracy is Eliminated and the possibility of installing unintended Viruses, Trojans or Worms onto ones System is also removed from the Equation; making the Systems Virtually Virus Proof, Trojan Proof and Worm Proof.

All Executable and Installable Application (essentially all Software) including Macros e.g. in a Word Document, an Excel Spread Sheet etc. need to have an Encrypted Machine ID and the Authors Permission for them to be Activated on the Destination Machine, as part of the Originating Source Code and to allow Traceability. Thus All Executable and Installable Applications (Software Products) should and ought to be Intellectual Property and hence Designated as Copy Protected and Not Installable without due Authentication from the Manufacturer of Software Product. Hence, ALL Viruses, Trojans or Worms would become Uninstallable due to Lack of a Valid Authentication Process and or a Designated, Verified and Secure Clearing House.

As an Additional part of this TSR . . . . It would then be an Automatic Requirement of All Software that the Software Writer ID becomes a part of the Machine ID and is automatically Appended at multiple points in the Document/Media where it is not traceable or alterable or deleteable or editable with encrypted machine Readable Date and Time to the Software being Written in Machine Language, and thus by the virtue of the TSR fundamentally Tamper Proof and Non Deleteable, Traceable and Trackable. At the Time of its Publication a Master Manufacturer of Software Product ID and Serial Number would be further Appended to the Software along with the Date and Time of its Publication. Hence again, ALL Viruses, Trojans or Worms would become Uninstallable due to Lack of a Valid Authentication Process and or a Designated, Verified and Secure Clearing House.

Yet another feature of this Invention is to have a Large SD Card Bank (or Mini SD Card or Mico SD Card etc.) and All of the Critical Parts of the Operating System are installed on very First Card By Virtue of these being ROM (Read Only Memory) they are pre-Burned Operating System (pre-Burned at the Factory) and provide two very Special Features: 1) Being they are Factory Supplied they are Tamper Proof and virtually Plug and Play Instant Start Operating Systems . . . 2) They cannot be knocked off kilt by Viruses, Trojans or Worms. The Other Slots in the SD Card Bank are likewise for Other Popular Programs such as MS Office etc. . . . and again these would be Tamper Proof and virtually Plug and Play Instant Start Programs . . . . Thus eliminating the need to Pirate by letting the Consumer have them at a extremely reasonable price. Additionally these could be individually encrypted and Serialized and hence virtually Pirate Proof by the above mentioned TSR and a Valid Authentication Process.

Software Companies frequently come up with updates and patches . . . these however could be Resident on the HDD (Hard Disk of the System) and patched in after Booting the System . . . . Hence the Basic Programs are Corrupt Proof, Virus Proof, Trojan Proof and Worm Proof . . . by being able to Suppress any Patches after the System has booted and Re-Installing the Patches even if they have been deliberately deleted . . . .

Yet another feature of this System is Move the Digital Data to another Bin if there is any attempt to Delete it by a Malicious Software and making it even more Corrupt Proof, Virus Proof, Trojan Proof and Worm Proof . . . . Thus with the ability to Bring it Back (Bring-Back, Restore etc.) the Malicious Software Maker can be traced back and stopped from distributing more Malicious Software.

It is further envisioned, the Centeral Clearing House could be made up of Three Independent Agencies as in the Case of the FICO Score . . . and the Joint Score/Rating of the Three Independent Agencies would determine the Trustworthiness of the Software Manufacturer.

### BRIEF DESCRIPTION OF THE DRAWINGS

FIG. 1 Symbolically represents the Preferred Embodiment of the present Invention.

FIG. 2 Represents the TSR (Terminate and Stay Resident) Program of the present system in a Block Diagram.

FIG. 3 Represents the TSR and the preferred embodiment of the present System in the form of a Flow Chart.

### DESCRIPTION OF THE PREFERRED EMBODIMENTS

### Specification

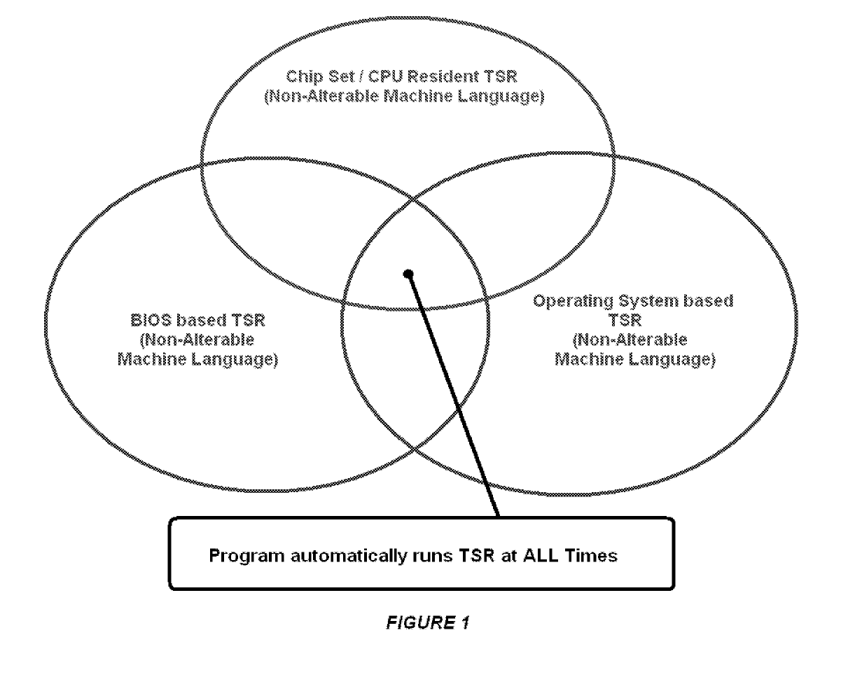

FIG. 1 symbolically represents the Preferred Embodiment of the present Invention. Most importantly the TSR (Terminate and Stay Resident) Program is pre installed on to the Chip Set (the CPU), which cannot be Uninstalled or Deleted. Concurrently the TSR is further enhanced/supplemented and endorsed in the BIOS of the System and lastly The TSR is Updated via the OS (Operating System) and the subsequent OS Updates. Thus the TSR automatically runs in the background at all times, and is Self Monitoring and Uninstall able. Because of its Basic Requirement (Presence) in the Chip Set any BIOS Manufacturer and the OS Manufacturer would need to be aligned with the Need for the TSR essentially following a certain protocol. Thus making it very Powerful and Undefeatable.

Although it would be best o have the TSR Permanently Resident in machine Language in the Chip Set (CPU) it could be Resident in one of the SD Card ROMS as mentioned above in the Summary, which however could be easily removed, but then the BIOS and the Operating System would by design Crash the System (Not allow the System to Boot) with it NOT being there in place as part of the TSR Mandated System.

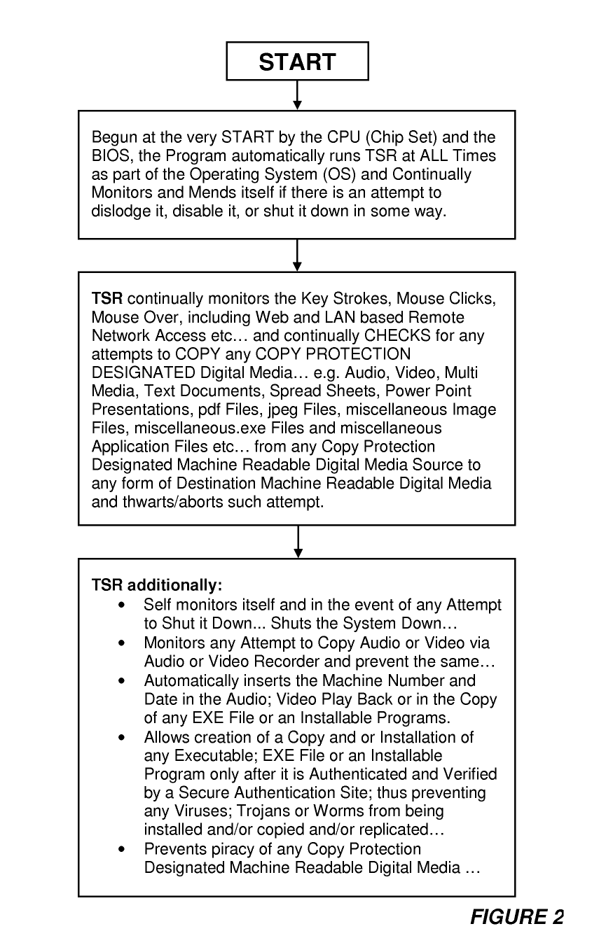

FIG. 2 Represents the TSR (Terminate and Stay Resident) Program of the present system in a Block Diagram.

As a preferred Embodiment of the Present Invention the TSR is an intrinsic part of any Machine Readable Media and the Machine it is read on or Copied onto. As a part of the TSR Mandate, the TSR is preinstalled on the CPU (the Chip Set) and is by the same Mandate a part of the BIOS for the BIOS to Function properly and adequately . . . likewise the same Mandate requires for a Valid and Current matching TSR to be part of the Operating System (OS) and in any Updates thereof.

Thus the TSR is begun automatically at the very START of the operation at BOOT by the CPU (Chip Set) and the BIOS, the Program. TSR runs at ALL Times as part of the Operating System (OS) and Continually Monitors and Mends itself if there is an attempt to dislodge it, disable it, or shut it down in some way.

The Copy Protection Designated Machine Readable Digital Media is any Copy Righted Materials which fall in two Categories: Digital Data Files and Digital Executable, Installable Programs (i.e. that which would fall in the Software Development Category) Intrinsically Both come under the Intellectual Property Category and hence worthy of Copy Protection.

The TSR then continually monitors the Key Strokes, Mouse Clicks, Mouse Over, including Web and LAN based Remote Network Access etc. . . . and continually CHECKS for any attempts to COPY any COPY PROTECTION DESIGNATED Digital Media . . . e.g. Audio, Video, Multi Media, Text Documents, Spread Sheets, Power Point Presentations, pdf Files, jpeg Files, miscellaneous Image Files, miscellaneous.exe Files and miscellaneous Application Files etc. . . . from any Copy Protection Designated Machine Readable Digital Media Source to any form of Destination Machine Readable Digital Media and thwarts/aborts such attempt.

The TSR additionally:

Self monitors itself and in the event of any Attempt to Shut it Down . . . Shuts the System Down . . .

Monitors any Attempt to Copy Audio or Video via Audio or Video Recorder and prevent the same . . .

Automatically inserts the Machine Number and Date in the Audio; Video Play Back or in the Copy of any EXE File or an Installable Programs.

Allows creation of a Copy and or Installation of any Executable; EXE File or an Installable Program only after it is Authenticated and Verified by a Secure Authentication Site; thus preventing any Viruses; Trojans or Worms from being installed and/or copied and/or replicated . . .

Prevents piracy of any Copy Protection Designated Machine Readable Digital Media . . .

Although duly authenticated, the machine number, date and time stamp encrypted into the played back and or recorded digital materials makes it traceable and trackable. Additionally foiling further un-authorized digital play back or digital recording.

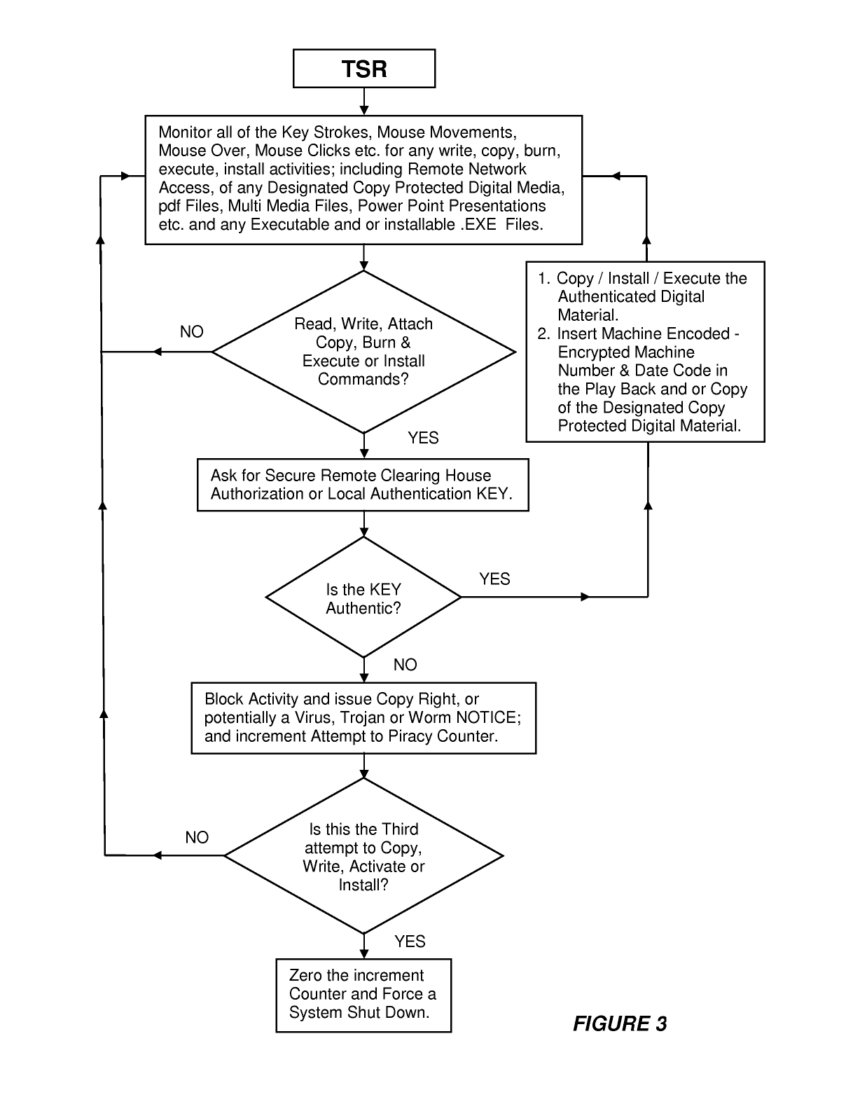

FIG. 3 Represents the TSR and the preferred embodiment of the present System in the form of a Flow Chart.

The TSR Monitors all of the Key Strokes, Mouse Movements, Mouse Over, Mouse Clicks etc. for any write, copy, burn, execute, install activities; including Remote Network Access, of any Designated Copy Protected Digital Media, pdf Files, Multi Media Files, Power Point Presentations, image Files etc. and any Executable and or installable .EXE Files.

The TSR then asks for Secure Remote Clearing House Authorization or Local Authentication KEY.

The lack of Authentication from the Three Authentication Bureaus and a legitimate Software Manufacturer would thwart the attempt to Copy, Play, Record, Execute, Install the Copy Protection Designated Machine Readable Digital Media.

Additionally the unauthenticateable Malicious Software could then be swiftly traced back to the machine it was produced on including the Software Developer and essentially immediately and remotely shutdown it down and make it inaccessible until further investigation, review and authentication . . . furthermore by virtue of the TSRs continuous Monitoring and Auto Routine to Date and Time Stamp everything any Malicious Software would not to be installed or propagated on to other machines.

Furthermore by Virtue of the Machine ID and Date Stamp being inserted on the fly on Play Back of the Audio/Video including the Display of Still Images and Dynamic Gif Images, including FLASH Objects, Power Point Presentations etc. there is a continuous History of Hand me Down(s) Auto-Tracking established in the Process for due Auditing of Secondary Piracy Activity of Copy Righted Materials in the Market Place.

The Anti-Virus Proof, Crash Proof Instant Start Computer intrinsically includes preloaded bundled Copy Protection Software and Self Preserving Operating System(s) and Software.

It is like Very Basic Artificial Intelligence/Self healing Technology. As one thread is broken the other two recreate the one deleted before you can delete one of the other two.

Hard wired Firmware based TSR (Terminate & Stay Resident executable Programs) are Fool Proof, Crash Proof and Spoof Proof and are additionally distinguished by hard wired (physical) key board; mouse and fingerprint reader machine inputs from software (program) generated delete; copy; paste and move input commands thus monitoring/protecting/distinguishing all spoofed virus, worm and trojan damage/problem causing malware (“malicious software”) commands from genuine user generated commands.

Additional embodiments are:

A Machine Resident Copy Protection TSR (Terminate and Stay Resident) Computer Program that continuously monitors Key Strokes, Mouse Over, Mouse Movements and Mouse Clicks, and aborts any attempt to copy any Copy Protection Designated Digital Data and any such designated materials such as programs, EXE Files, Audio Files, Video Files, Image Files, Data Files or any of their respective equivalent Files formats those are pre designated to be Copy Protected. The said TSR is resident in the Chip Set on the Mother Board of the System or the CPU of the System. The said TSR is resident in the BIOS of the System. The TSR is resident in the OS (the Operating System) Software of the System. The TSR is self Monitoring and Self Healing or Self Restoring and if that were to fail it shuts down the System.

The TSR asks for a Secure Remote Clearing House Authorization or a Local Authentication Key and prevents any play back, displaying or copying of the Digital Media or installation of the Software without the Authentication Key, wherein the said Clearing House may include Three Authentication Bureaus and further includes a legitimate Source or Manufacturer of the Software sought to be installed or executed; or the Producer or Publisher of the Designated Digital Media sought to be played, recorded or displayed.

The TSR automatically inserts an encrypted Machine Number and Date and Time Stamp in the Digital Media being played back, copied or installed for traceability to its Source and for preventing future digital copying and playback.

The TSR and the Operating System are Resident on any Digital Storage Media such as on SD Card or a Mini SD Card or any other format or form such as those that can be plugged into a Socket or a Cluster of Sockets in the System. The Operating System (OS) is plug and play and the said Digital Storage Media in any form thereof is a ROM (a Read Only Memory).

A Machine Resident Copy Protection TSR (Terminate and Stay Resident) Computer Program and its Operating System (OS) in which the TSR and the OS are resident on any Digital Storage Media such as on SD or a Mini SD Card or any other format or form such as those that can be plugged into an SD Card like Socket or a Cluster of Sockets in the System. The Operating System (OS) is plug and play and the said digital storage media or in any form thereof such as a ROM (a Read Only Memory).

Any installable program is pre-installed on to a digital storage media similar to the said digital storage media or in any form thereof such as a ROM (a Read Only Memory). A machine resident copy protection TSR (Terminate and Stay Resident) computer program that acts as a self healing, self mending, corrupt proof, fail proof, uninstallable program that thwarts or prevents any unauthorized playing back, copying, duplicating, recording, storing, installing, executing of digital media without a local or remote Authorized Authentication Key. Upon presentation of the Authorized Authentication Key the machine inserts the machine number, date and time stamp encrypted into the played back and or recorded digital materials thus making it traceable and trackable, and foils any further un-authorized digital play back, digital recording, execution or installation of the copy protected digital media.

An anti-virus proof, crash proof instant start computer that intrinsically includes preloaded bundled Copy Protection Software, BIOS and OR Operating Systems.

I claim:

1. A product for preventing unauthorized copying of computer readable data comprising:
a program installed on a computer comprising the following properties,
said program is permanently installed on said computer,
said program cannot be disabled due to a self preservation function, said self preservation function comprising multiple running copies of said program wherein an attempt to shutdown or delete one program results in one of the other copies restoring the program,
said program detects attempts to copy any copy-protected computer readable data,
wherein said program blocks said attempts to copy any copy-protected computer readable data thereby preventing unauthorized copying.

2. The product as defined in claim 1 wherein said permanently installed program is pre-installed.

3. The product as defined in claim 1 wherein said permanently installed program has a location selected from the group consisting of: the mother board, the chip set and the BIOS.

4. The product as defined in claim 1 wherein said program detects said copy attempts by monitoring requests to access said copy protected computer readable data.

5. The product as defined in claim 4 wherein said monitoring is selected from the group consisting of: monitoring the user's key strokes, monitoring the user's computer mouse input and monitoring remote network copy requests.

6. The product as defined in claim 1 wherein a key unique to the computer upon which the product is permanently installed is detected and associated with said copy-protected computer readable data such that when copying is attempted, said associated key is compared to the key of the computer on which the copying is attempted and if said keys do not match said attempt to copy is blocked.

7. The product as defined in claim 1 wherein said key is derived from records selected from the group consisting of: serial numbers, machine numbers, manufacture dates and purchase dates.

8. The product as defined in claim 1 wherein said copy protected computer readable data is selected from the group consisting of: computer programs, EXE files, audio files, video files, image files and data files.

9. A method of preventing unauthorized copying of computer readable data comprising:
permanently installing a program on a computer,
multiple running copies of said program wherein an attempt to shutdown one program results in one of the other copies of the program restoring function,
detecting attempts to copy any copy-protected computer readable data and to block said attempts to copy any copy-protected computer readable data,
wherein said blocking of copy attempts prevents unauthorized copying of computer readable data.

10. The method as defined in claim 9 wherein said program detects said copy attempts by monitoring requests to access said copy protected computer readable data.

11. The method as defined in claim 10 wherein said monitoring is selected from the group consisting of: monitoring the user's key strokes, monitoring the user's computer mouse input and monitoring remote network copy requests.

12. A product for protecting computer data comprising:
a program installed on a computer comprising the following properties,
said program is permanently installed on said computer,
said program cannot be disabled due to a self preservation function, said self preservation function comprising multiple running copies of said program wherein an attempt to shutdown or delete one program results in one of the other copies restoring the program,
said program detects attempts by an unauthorized computer program to alter any data on the computer,
wherein said program blocks said attempts to alter said data thereby protecting said computer data.

13. The product as defined in claim 12 wherein said permanently installed program is pre-installed.

14. The product as defined in claim 12 wherein said permanently installed program has a location selected from the group consisting of: the mother board, the chip set and the BIOS.

15. The product as defined in claim 12 wherein said unauthorized computer program is selected from the group consisting of: viruses, trojans and worms.

16. The product as defined in claim 12 wherein a key unique to the computer upon which the product is permanently installed is detected and wherein software installed on said computer must be validated with said unique key to properly run on said computer.

17. The product as defined in claim 16 wherein said program monitors software running on said computer and software that is not validated becomes unstable.

18. The product as defined in claim 16 wherein said key is derived from records selected from the group consisting of: serial numbers, machine numbers, manufacture dates and purchase dates.

19. The product as defined in claim 16 wherein said validation is performed by reference to a master list located at a third party clearinghouse.
